(19) United States
(12) Patent Application Publication
(10) Pub. No.: US 2007/0081807 A1
(43) Pub. Date: Apr. 12, 2007

(54) Method of remote controller via computer to indirectly control image-generating apparatus

(75) Inventor: Peng-Cheng Lai, Panchiao (TW)

Correspondence Address: BIRCH STEWART KOLASCH & BIRCH, PO BOX 747, FALLS CHURCH, VA, 22040-0747, US

(73) Assignee: Ortery Technologies, Inc.

(21) Appl. No.: 11/365,888

(22) Filed: Mar. 2, 2006

(30) Foreign Application Priority Data
Oct. 11, 2005 (TW) 094135355

(51) Int. Cl. G03B 17/00

(52) U.S. Cl. 396/56

(57) ABSTRACT

A method of a remote controller to indirectly control an image-generating apparatus via a computer is utilizing a remote controller to emit a control signal and then the control signal is received and transformed by a receiving/transforming device. The transformed signal is received by a computer and then processed to transform into another control signal to transmit to an image-generating apparatus to execute the received signal.

### BACKGROUND OF THE INVENTION

1. Field of the Invention

The present invention relates to a control technology for an image-generating apparatus, particularly to a method of a remote controller to indirectly control an image-generating apparatus via a computer.

2. Description of the Related Art

Since image-generating apparatus, e.g., digital camera, were popularly applied, most of them have been used in taking pictures of commercial products and scenery; however, it is rare to directly control by a remote controller in order to conduct self-shooting or make photography more easy and efficient.

As a matter of fact, only few manufacturers of digital cameras have supplied the remote controller to directly control the cameras. However, due to the small size of LCDs built in the cameras, the objects taken can hardly be previewed well. In addition, the quality of the pictures taken cannot promptly be shown on a computer screen and the pictures cannot immediately be saved into a computer. Moreover, due to the limits of the camera's memory and control capability, many basic and critical setting functions of a camera, such as Exposure, Aperture and Shutter Speed, cannot be executed via the remote controller; to the contrary, only very simple functions, such as Preview, Zoom in/Zoom out and Snap, can be operated via the remote controller.

Apparently, the current technology regarding directly controlling image-generating apparatus by a remote controller has many deficiencies, i.e., the setting functions cannot be fully performed, the preview effect is insufficient, the quality of the pictures taken cannot immediately be shown and the image editing software be integrated which causes the technology cannot be popularly applied.

### SUMMARY OF THE INVENTION

One of objectives of the present invention is to provide a method for previewing the image other than from an image-generating apparatus. It utilizes a large-size display panel rather than the image-generating apparatus to promptly preview the image so as to accurately handle the light status of the environment, the object or the person and to immediately correct the settings of the image-generating apparatus resulted in obtaining a better image quality that can avoid prevent to repeat trying different setting values of the image-generating apparatus.

Another one of objectives of the present invention is to provide a method for setting photographic parameters of an image-generating apparatus. The using of the computer can simplify the setting of photography parameters and integrates more complete function settings of the image-generating apparatus on the limited keys of the remote controller so as the remote controller can do remote capturing to create better image quality without back and forth to change the settings on the image-generating apparatus.

Further, one of objectives of the present invention is to provide a method for storing the image from the image-generating apparatus. The created image is directly stored into the computer so as the image can be displayed on the computer and then can integrate with the editing software in the computer.

In order to achieve the above-mentioned objectives, one embodiment of the present invention proposes a method of a remote controller via a computer to indirectly control an image-generating apparatus includes the following steps: emitting a first control signal from the remote controller; receiving and transforming the first control signal into a second control signal; receiving the second signal by the computer; processing the second signal transforming into a third control signal and transmitting the third control signal; and then receiving and executing the third control signal by the image-generating apparatus.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic diagram showing a system of a remote controller via a computer to control an image-generating apparatus used in the method in accordance with one embodiment of the present invention;

FIG. 2 is a schematic diagram showing the user interface of the display of the computer under the auto mode of the camera mode in accordance with one embodiment of the present invention;

FIG. 3 is a schematic diagram showing the user interface of the display of the computer under the manual mode of the camera mode in accordance with one embodiment of the present invention; and

FIG. 4 is a flowchart of the method of a remote controller to indirectly control an image-generating apparatus via a computer in accordance with one embodiment of the present invention.

### DETAILED DESCRIPTION OF THE INVENTION

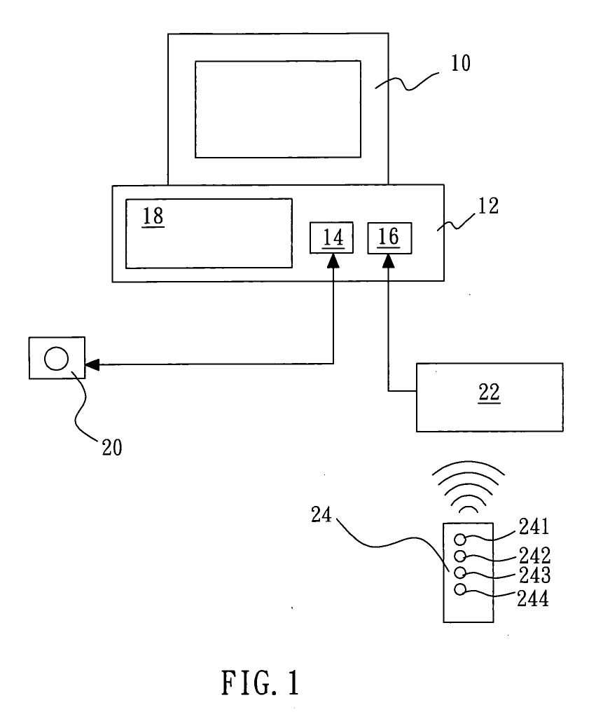

FIG. 1 is a schematic diagram illustrated a system of a remote controller via a computer to control an image-generating apparatus used in the method in accordance with one embodiment of the present invention. A computer host 12 provided with a large-size display panel 10 has a plurality of input/output ports 14 and 16, such as the universal serial bus (USB). The computer host 12 is installed an execute/control program 18 of the image-generating apparatus. The image-generating apparatus 20 utilizes the transmitting line to connect to the input/output port 14 to communicate with the computer host 12. Next, the present system includes a receiving/transforming device 22 connecting to the input/output port 16 for communicating with the computer host 12. The image-generating apparatus 20 can be one of the digital camera, the digital video camera, the CCD camera, the PC camera or the web/IP camera. The remote controller 24 can utilize the receiving/transforming device 22 via the USB signal, the RS-232 signal or the IEEE1394 signal to communicate with the computer host 12. The remote controller 24 can be the wire remote controller or the wireless remote controller, which has a plurality of keys 241, 242, 243, and 244.

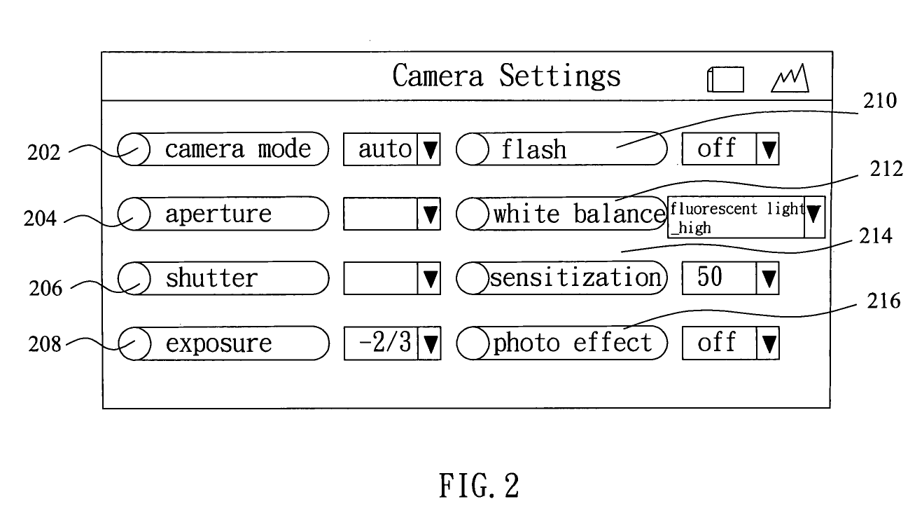

Following the foregoing, in one embodiment of the present invention, the key 241 of the remote controller 24 can switch the control option, and the controllable mode of the key 241 is totally decided by the camera mode 202, either set at the auto mode or the manual mode on the user interface (as shown in FIG. 2) within the execute/control program 18. Once the control mode of the key 241 is decided, the key 242 and the key 243 will be the increasing value and the decreasing value of the selected mode for the key 241.

Once the camera mode 202 of the user interface within the execute/control program 18 is selected as the auto mode, the key 241 can only switch to two control options of the zoom mode or the exposure mode. If the zoom mode is selected, the key 242 and the key 243 can adjust the zoom-in function and the zoom-out function. While the exposure mode is selected, the key 242 and the key 243 can adjust the function of increasing the exposure value and decreasing the exposure value. The key 244 can control the preview/snap function in all different modes.

Referring to FIG. 2, it is a schematic diagram illustrated the user interface of the display panel of the computer under the auto mode of the camera mode in accordance with one embodiment of the present invention. Once the auto mode of the camera mode 202 is selected on the computer, the aperture value 204 (Av) and the shutter value 206 (Tv) cannot be adjusted and the user can only adjust the exposure value 208 (Ev). Other options of camera settings, such as the flash 210, the white balance 212, the sensitization 214 and the photo effect 216, are adjustable by the user according to the lighting environment no mater the auto mode or the manual mode being selected.

Once the manual mode of the camera mode 202 is selected, the key 241 can only switch to the zoom mode, the aperture (Av) mode and the shutter (Tv) mode. If the zoom mode is selected, the key 242 and the key 243 can adjust the zoom-in function and the zoom out function. As the aperture mode is selected, the key 242 and the key 243 can adjust to increase the aperture value and decrease the aperture value. While the shutter mode is selected, the key 242 and the key 243 can adjust to increase the shutter value and decrease the shutter value. The key 244 can control the preview/snap function in all different modes.

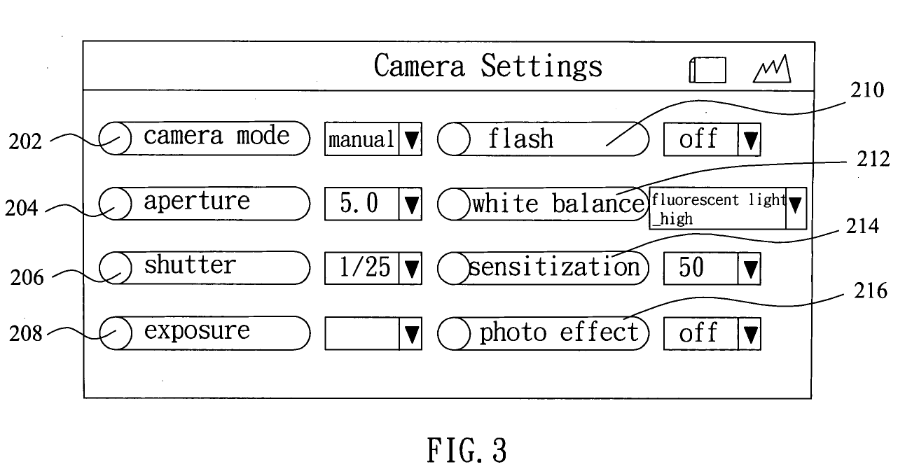

Referring to FIG. 3, it is a schematic diagram illustrated the user interface of the display panel of the computer under the manual mode of the camera mode 202 in accordance with one embodiment of the present invention. Such as shown in FIG. 3, once the manual mode of the camera mode 202 is selected on the computer, the exposure value (Ev) 208 cannot be adjusted and the user can only adjust the aperture value (Av) 204 or the shutter value (Tv) 206.

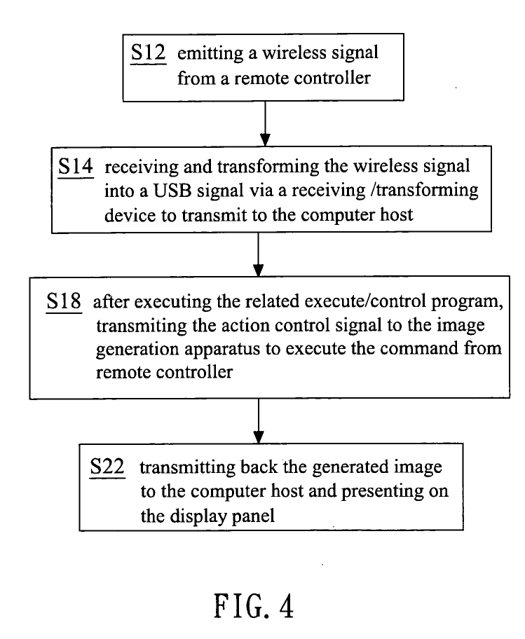

FIG. 4 is a flowchart illustrates the method of a remote controller to indirectly control an image-generating apparatus via a computer in accordance with one embodiment of the present invention. First, the user utilizes the key on a remote controller to emit a wireless signal (Step S12). The remote controller can use the way of the infrared rays, the radio frequency or the blue tooth to transmit the signal. A receiving/transforming device is used for receiving the signal from the remote controller and transforming into an Universal Serial Bus (USB) signal and then transmit to the computer host via the input/output port (Step S14). Next, after the USB signal input to the computer executing the related execute/control program, via the input/output port of the computer, the action control signal is transmitting through the transmitting line to the image-generating apparatus so as to send the command of the remote controller to the image-generating apparatus (Step S18). Following, after the image-generating apparatus completing the corresponding response of the order, the generated image is transmitted back to the computer host and presenting on the display panel (Step S22).

Following the foregoing, the remote controller is through the computer host to indirectly control the action of the image-generating apparatus, so the user can clearly preview the lighting environment of the photographed object or person, especially the photographer himself/herself, and can proceed the adjustment of the aperture value, the shutter value, or other photographic parameters via the remote controller. Because of the use of the computer, function settings of the image-generating apparatus that the remote controller can be controlled is more completed and the quality of the created image can be immediately displayed on the display panel. If the image quality is not good enough, the user can immediately change the setting on the remote controller until the satisfied image quality could be obtained. However, the created images can immediately and directly be stored into the computer host and can be integrated with the editing software in the computer.

Accordingly, one of features of the present invention is to solve the inconvenience problem from the image-generating apparatus without indirectly controlling via the computer host. Without the invention those user who use the image-generating apparatus must repeat to do preview the image, snap the image, and try many times on the setting of the image-generating apparatus until satisfied images were achieved. Further, created images are difficult to integrate with the image editing software in the computer host.

The difference between the present invention and the prior technology is that the present invention utilizes the computer and the display panel to integrate the control function of the remote controller and to clearly preview at remote photography so as can save more photographic time and obtain the higher image quality. However, the prior technology directly utilizes the remote controller to control the image-generating apparatus. The preview window is small and the remote controller can only choose one control mode of automatic zoom-in or zoom-out but without the remote adjustment function of the exposure, the aperture, and the shutter. The prior technology distinctly could not adequately use the fully functions that the image-generating apparatus should have.

While the present invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A method of a remote controller via a computer to indirectly control an image-generating apparatus, comprising the following steps:
emitting a first control signal from said remote controller;
receiving and transforming said first control signal into a second control signal;
receiving said second signal by said computer;
processing said second signal transforming into a third control signal and transmitting said third control signal; and
receiving and executing said third control signal by said image-generating apparatus.

2. A method of a remote controller via a computer to indirectly control an image-generating apparatus according to claim 1, wherein the step of emitting said first control signal comprises utilizing any one of the wire way and the wireless way to transmit said first control signal.

3. The method of a remote controller via a computer to indirectly control an image-generating apparatus according to claim 2, wherein the wireless way to transmit said first control signal is any one of transmitting way of the infrared rays, the radio frequency, and the blue tooth.

4. The method of a remote controller via a computer to indirectly control an image-generating apparatus according to claim 1, wherein the step of receiving and transforming said first control signal further comprises transforming said first control signal into the universal serial bus (USB) signal, the RS-232 signal or the IEEE1394 signal.

5. The method of a remote controller via a computer to indirectly control an image-generating apparatus according to claim 1, wherein the step of transmitting said third control signal comprises transmitting the universal serial bus signal, the RS-232 signal or the IEEE 1394 signal.

6. The method of a remote controller via a computer to indirectly control an image-generating apparatus according to claim 1, wherein said image-generating apparatus is any one of the digital camera, the digital video camera, the CCD camera, the PC camera or the web/IP camera.

7. The method of a remote controller via a computer to indirectly control an image-generating apparatus according to claim 1, wherein said first control signal is configured for at least any one of function settings of previewing, zooming, the exposure value, the aperture value, the shuttering value and snapping of said image-generating apparatus.

8. The method of a remote controller via a computer to indirectly control an image-generating apparatus according to claim 7, further comprising displaying said function settings on a display of said computer.
